(19) United States
(12) Patent Application Publication
(10) Pub. No.: US 2007/0115690 A1
(43) Pub. Date: May 24, 2007

(54) Method for producing a light guide plate and method for making a core insert for a light guide plate

(75) Inventor: Guo-Han Yue, Shenzhen (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/502,665

(22) Filed: Aug. 10, 2006

(30) Foreign Application Priority Data
Nov. 18, 2005 (TW) 94140641

(51) Int. Cl. F21V 7/22

(52) U.S. Cl. 362/627

(57) ABSTRACT

A method of producing a light guide plate, comprising the steps of: (a) providing a base board and a dispenser having a cylinder and a nozzle connecting the cylinder, wherein the cylinder is filled with a binding substance; (b) positioning the nozzle above an area of the base board according to a predetermined pattern and unloading a suitable quantity of the binding substance on the area of the base board; (c) solidifying the binding substance adhered to the base board; (d) repeating steps (b) and (c) appropriately in turn to form a predetermined number of pattern dots on the base board, whereby the light guide plate is formed. A method of making a core insert for a light guide plate is also provided. The present methods have a high precision pattern dots design, and can also put into practice easily.

1. Technical Field

The present invention relates to methods for producing light guide plates and methods for making core inserts for a light guide plate, more particularly, to methods for manufacturing a light guide plate having predetermined optical properties.

2. Background

A typical liquid crystal display device includes a liquid crystal display panel, and a backlight module mounted adjacent the liquid crystal display panel for supplying light thereto. The backlight module mainly includes a light source and a light guide plate. The light guide plate is made of a transparent acrylic plastic, and is used for guiding light beams received from the light source to uniformly illuminate the liquid crystal display panel.

The light source emits light beams into the light guide plate, and at least some of the light are liable to be totally internally reflected within the light guide plate. In order to diffuse the light rays and emit uniformly out a top surface of the light guide plate, microstructures such as protrusions, recesses or dots are formed at a bottom surface of the light guide plate.

Light guide plates having microstructures may be manufactured by two conventional methods: a printing method and a non-printing method. In the printing method, the microstructures are a plurality of light diffusing substances comprising titanium oxide, glass beads, or the like. A predetermined pattern of the microstructures is screen printed on the bottom surface of the light guide plate. However, using this method, the smallest possible size of each microstructure is about 300 microns, and controlling the precision and variability of the shapes of microstructures is limited.

Injection molding and extrusion molding methods are two typical non-printing methods for mass producing light guide plates with microstructures. Generally, the molding methods are considered to be superior to the printing methods because the quality of the microstructures manufactured by molding methods is better than that of printing methods. A typical molding method for making a light guide plate has the following steps of: designing optical patterns of a light guide plate; designing and producing a mold; forming a core insert having microstructures corresponding to the microstructures of the light guide plate; manufacturing the light guide plate by using the mold and the core insert; inspecting the optical performance of the light guide plate, wherein if the optical performance is consistent with a predetermined configuration, the mold and the core insert can be used to mass produce the light guide plate; contrarily, if the optical performance of the light guide plate is inconsistent with the predetermined configuration, repeating the above steps in order again until the light guide plate has suitable optical performance.

However, the process of designing and manufacturing the core insert of this typical method is time-consuming. In addition, a typical method to produce a core insert usually employs laser beams to etch a surface of the core insert, thus, it can be difficult to control the precision of the micro patterns of the core insert corresponding to the microstructures formed on the light guide plate.

Therefore, it is desired to provide a new method for producing a light guide plate having light dispersing microstructures, and a new method for manufacturing the core insert for the light guide plate that can overcomes the above-described disadvantages of conventional method.

### SUMMARY

In one aspect, a method for producing a light guide plate according to a preferred embodiment includes the steps of: (a1) providing a base board and a dispenser having a hollow cylinder and a nozzle connecting to the cylinder, wherein the cylinder is filled with a binding substance; (b1) positioning the nozzle above an area of the base board according to a pattern and unloading a suitable quantity of the binding substance on the area of the base board to form a pattern dot; (c1) solidifying the pattern dot; (d1) repeating steps (b1) and (c1) appropriately in turn to form a predetermined number of pattern dots on the base board, whereby the light guide plate is formed.

In another aspect, a method for making a core insert for a light guide plate according to a preferred embodiment includes the steps of: (a2) manufacturing a light guide plate by the method as described in the previous paragraph; (b2) inspecting an optical performance of the light guide plate, wherein if the light guide plate is consistent with a predetermined design of the light guide plate, entering the subsequent step (c2); contrarily, if the light guide plate is inconsistent with the predetermined design, repeating the steps (a2) through (b2) to form the light guide plate again; (d2) depositing a metal film on a surface having the pattern dots of the light guide plate; (e2) forming a depositing layer on the metal film by electroforming technology; (f2) stripping off the light guide plate from the metal film to form a core insert.

In still another aspect, another method for producing a light guide plate according to a preferred embodiment includes the steps of: (a3) manufacturing a core insert as described in the previous paragraph; (b3) providing a mold having a bottom mold part and an upper mold part, and removing the core insert between the bottom mold part and the upper mold part; (c3) manufacturing a second light guide plate by injecting melt resin materials into the mold; (d3) inspecting the optical performance of the second light guide plate, wherein if the second light guide plate is consistent with the predetermined design, mass producing the second light guide plate; contrarily, if the second light guide plate is inconsistent with the predetermined design, repeating the steps (a3) through (d3) appropriately in turn.

Other advantages and novel features will become more apparent from the following detailed description of the preferred embodiments, when taken in conjunction with the accompanying drawings.

### BRIEF DESCRIPTION OF THE DRAWINGS

Many aspects of the method of producing a light guide plate and the method for making a core insert for a light guide plate can be better understood with reference to the following drawings. The components in the drawings are not necessarily drawn to scale, the emphasis instead being placed upon clearly illustrating the principles of the present method of producing a light guide plate and the present method for making a core insert for a light guide plate. Moreover, in the drawings, like reference numerals designate corresponding parts throughout the several views.

FIG. 1 is a flow chart of a method of producing a light guide plate according to a first preferred embodiment;

FIG. 2A is a schematic, partially cross-sectional view of a nozzle of a dispenser being accurately positioned above an area of base board according to a predetermined pattern;

FIG. 2B is a schematic, partially cross-sectional view of the nozzle unloading a suitable quantity of a binding substance on the base board;

FIG. 2C is a schematic, partially cross-sectional view of a the binding substance being solidified on the base board;

FIG. 3 is a flow chart of a method of making a core insert for a light guide plate according to a second preferred embodiment;

FIG. 4 is a side view of a light guide plate and a metal film is formed on a surface having a plurality of pattern dots of the light guide plate according to the method of FIG. 4;

FIG. 5 is a side view of a depositing layer formed on the metal film of FIG. 4 according to the method of FIG. 3;

FIG. 6 is a side view of a core insert for a light guide plate produced according to the method of FIG. 3; and

FIG. 7 is a flow chart of a method of producing a light guide plate according to a third preferred embodiment.

### DETAILED DESCRIPTION OF THE PREFERRED EMBODIMENTS

Reference will now be made to the drawings to describe preferred embodiments of a method of producing a light guide plate and a method of producing a core insert for a light guide plate, in detail.

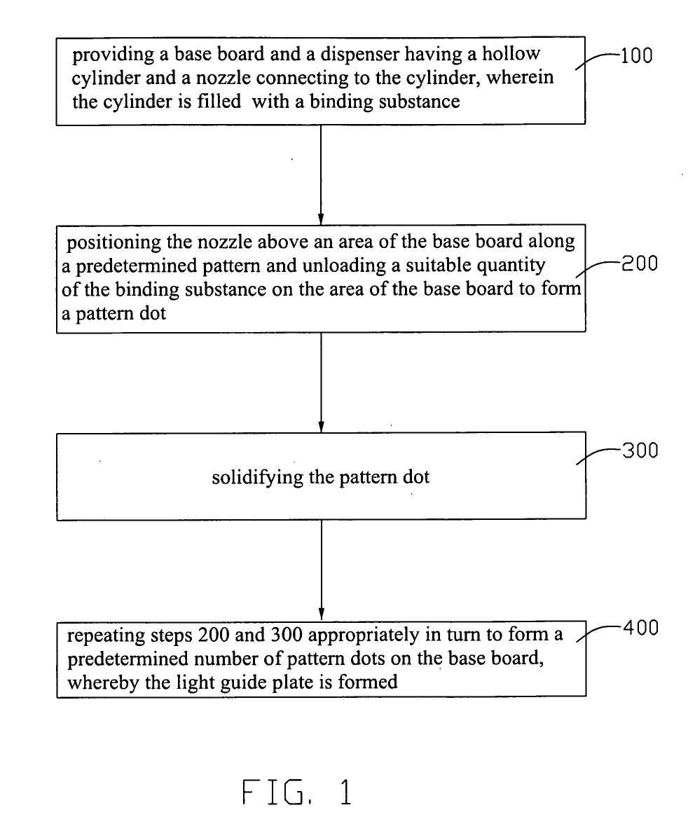

FIG. 1 is a flow chart of a method for producing a light guide plate according to a first preferred embodiment. The method includes the steps of:

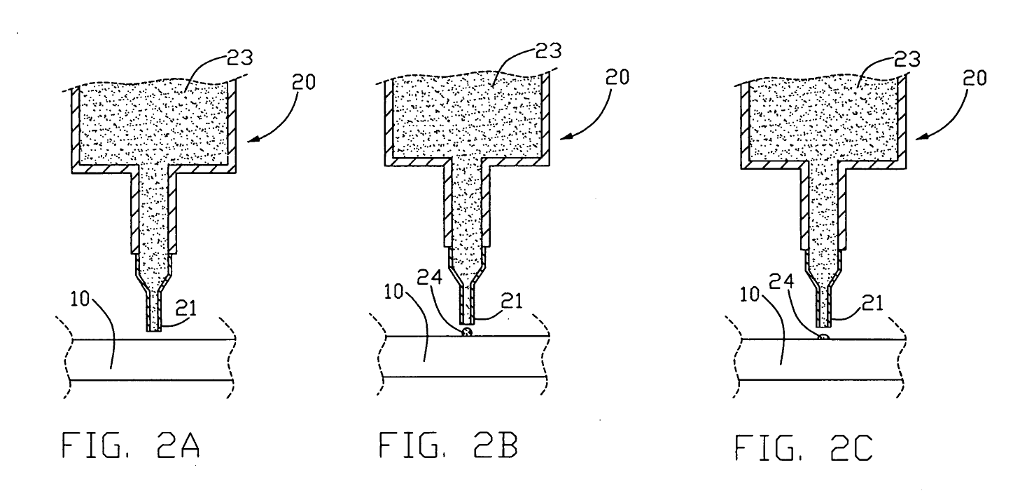

step 100: also referring to FIG. 2A, providing a base board 10 and a dispenser 20 having a hollow cylinder 22 and a nozzle 21 connecting the cylinder 22, wherein the cylinder 22 is filled with a binding substance 23;

step 200: also referring to FIG. 2B, accurately positioning the nozzle 21 above an area of the base board 10 along a predetermined pattern before unloading a suitable quantity of the binding substance on the area of the base board 10 to form a pattern dot 24;

step 300: also referring to FIG. 2C, solidifying the pattern dot 24;

step 400: repeating steps 200 and 300 appropriately in turn to form a plurality of pattern dots 24 on the base board 10, thereby a light guide plate is formed.

In step 100, a material of the base board 10 may be preferably selected from a group comprising of polymethyl methacrylate (PMMA), polycarbonate (PC), and/or the other suitable transparent resin materials. The binding substance may be selected from one of a UV-curing glue and a transparent thermo-curing glue. In this embodiment, the dispenser may employ a SHOTMASTER'300™ dispenser, produced by musashi-engineering company.

In step 200, when the suitable quantity of the binding substance 23 is projected to the base board 10 from the nozzle 21, the pattern dot 24 may be tightly adsorbed on the area of the base board after about more than ten seconds due to its viscosity. The pattern dots 24 may have a semi-spherical shaped protrusion due to surface tension of the pattern dots.

In step 300, the pattern dot 24 may be solidified by lighting or heating methods according to their characters of the binding substance 23. The lighting methods include UV lighting and/or lighting using visible light. An outer surface (not labeled) of the pattern dot 24 is an aspherical lens surface after the binding substance 23 is solidified. A bottom surface (not labeled) of the pattern dot 24 is substantially in contact with the base board 10, thus, a predetermined optical property of the subsequent light guide plate may be obtained.

In this embodiment, a plurality of the pattern dots 24 may be arranged on the base board 10 in a matrix manner, according to a predetermined design. Diameters of bottom surfaces of pattern dots 24 are configured to be about 80 nanometers, and a distance between adjacent two pattern dots 24 is configured to be about 200 nanometers.

It is to be understood that the size of the pattern dot and positioning precision are preferably obtained by dispenser. It is noted that selecting different binding substances may adjust the size and shape of each pattern dot. Similarly, controlling the dispenser's unloading rate and/or unloading pressure also may adjust the size and shape of each pattern dot.

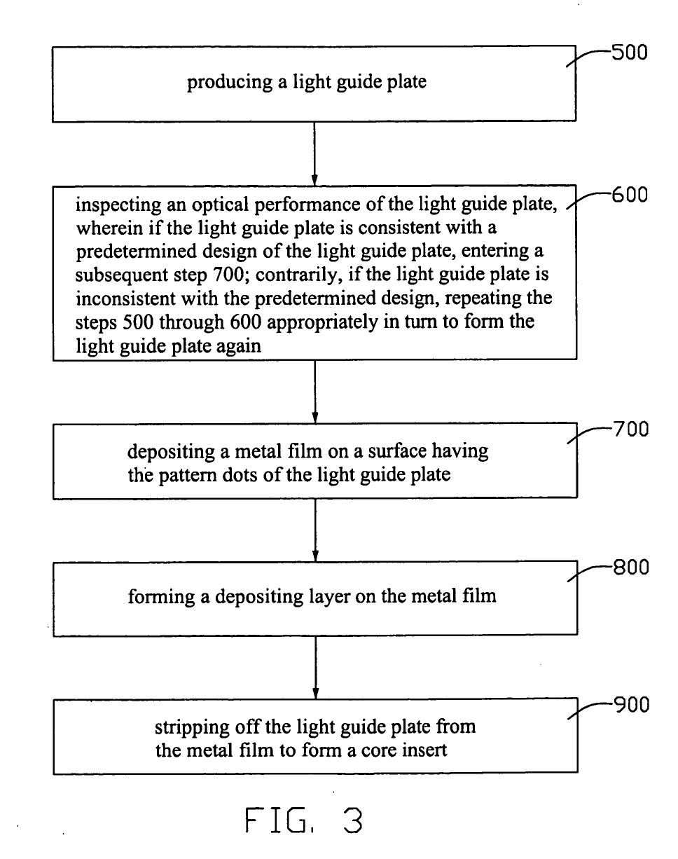

FIG. 3 is a flow chart of a method of manufacturing a core insert for the light guide plate according to a second preferred embodiment. The method includes the steps of:

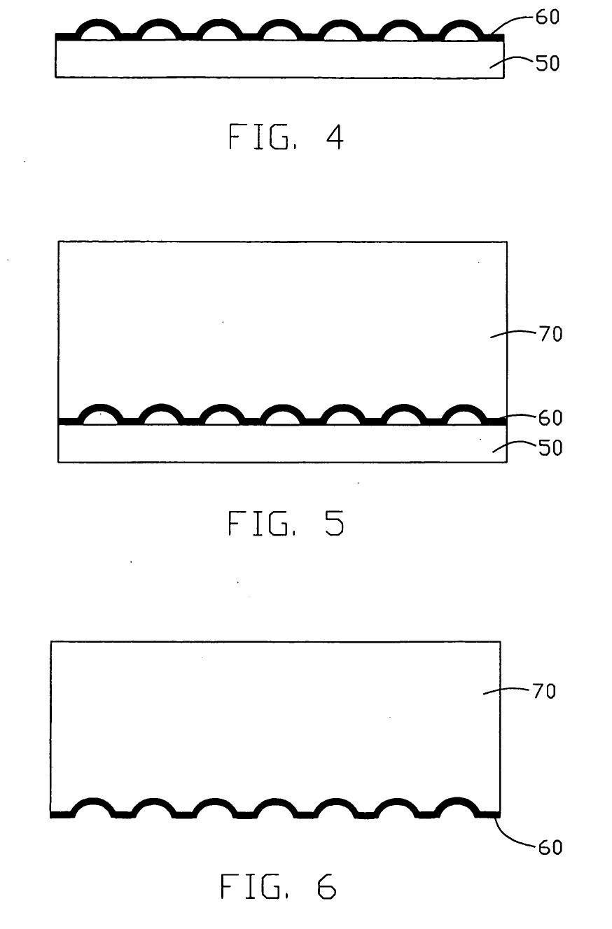

step 500: also referring to FIG. 4, producing the light guide plate 50 with the method described in previous paragraphs describing the first embodiment;

step 600: inspecting an optical performance of the light guide plate 50, wherein if the light guide plate 50 is consistent with a predetermined design of the light guide plate, entering a subsequent step 700; contrarily, if the light guide plate 50 is inconsistent with the predetermined design, repeating the steps 500 and 600 respectively to form the light guide plate again;

step 700: also referring to FIG. 4, depositing a metal film 60 on a surface of the light guide plate 50 having the pattern dots;

step 800: also referring to FIG. 5, forming a depositing layer 70 on the metal film 60;

step 900: also referring to FIG. 6, stripping off the light guide plate 50 from the metal film 60 to form a core insert.

In step 700, the metal film 60 may be deposited on the light guide plate 50 by thermal evaporation or by sputtering methods. The metal film 60 is preferably selected from a group of comprising a nickel, a phosphor-nickel and a combination thereof.

In step 800, the depositing layer 70 may be formed on the metal film 60 by electroforming method. The depositing layer 70 may be selected from metals or metal alloys. Preferably the depositing layer 70 may be also selected from a group of comprising a nickel, a phosphor-nickel and a combination thereof.

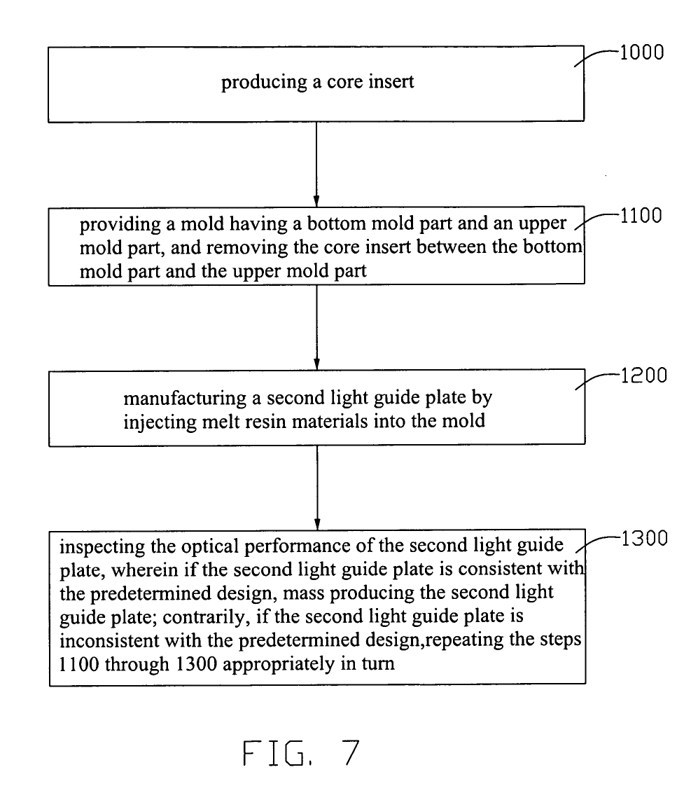

FIG. 7 is a flow chart of a method for producing a light guide plate according to a third preferred embodiment. The method includes the steps of:

step 1000: producing a core insert as described in the previous paragraphs according to the second embodiment;

step 1100: providing a mold having a bottom mold part and an upper mold part, and removing the core insert between the bottom mold part and the upper mold part;

step 1200: manufacturing a second light guide plate by injecting molten resin materials into the mold;

step 1300: inspecting the optical performance of the second light guide plate, wherein if the second light guide plate is consistent with the predetermined design, mass producing the second light guide plate; contrarily, if the second light guide plate is inconsistent with the predetermined design, repeating the steps 1100 through 1300 appropriately in turn.

In step 1200, the resin materials is the same as the base board 10 as described in the paragraph [0024].

Compared with the conventional method of producing a light guide plate, the present methods using the dispenser can producing a high precision pattern dots easily by controlling the dispenser according to a predetermined design. Furthermore, it is easier producing a high precision core insert with spreading pattern dots in accordance with the second embodiment.

Finally, while the present invention has been described with reference to particular embodiments, the description is illustrative of the invention and is not to be construed as limiting the invention. Therefore, various modifications can be made to the embodiments by those skilled in the art without departing from the true spirit and scope of the invention as defined by the appended claims.

What is claimed is:

1. A method for producing a light guide plate, comprising the steps of:
(a) providing a base board and a dispenser having a hollow cylinder and a nozzle connecting to the cylinder, wherein the cylinder is filled with a binding substance;
(b) positioning the nozzle above an area of the base board along a predetermined pattern and unloading a suitable quantity of the binding substance on the area of the base board to form a pattern dot;
(c) solidifying the pattern dot;
(d) repeating steps (b) and (c) appropriately in turn to form a predetermined number of pattern dots on the base board, whereby the light guide plate is formed.

2. The method according to claim 1, wherein the binding substance is selected from a group comprising a UV-curing glue and/or a transparent thermo-curing glue.

3. The method according to claim 1, wherein the step (c) employs one of lighting and heating to solidify the binding substance.

4. A method of producing a core insert for a light guide plate, comprising the steps of:
(a) providing a base board and a dispenser having a cylinder and a nozzle connecting to with the cylinder, wherein the cylinder is filled with a binding substance;
(b) positioning the nozzle above an area of the base board along a predetermined pattern and unloading a suitable quantity of the binding substance on the area of the base board to form a pattern dot;
(c) solidifying the pattern dot;
(d) repeating steps (b) and (c) appropriately in turn to form a predetermined number of pattern dots on the base board until the light guide plate is formed;
(e) inspecting an optical performance of the light guide plate, wherein if the light guide plate is consistent with a predetermined design of the light guide plate, entering a subsequent step (f); contrarily, if the light guide plate is inconsistent with the predetermined design, repeating the steps (a) through (e) appropriately in turn to form the light guide plate again;
(f) depositing a metal film on a surface having the pattern dots of the light guide plate;
(g) forming a depositing layer on the metal film;
(h) stripping off the light guide plate from the metal film to form a core insert for a light guide plate.

5. The method according to claim 4, wherein the binding substance is selected from a group comprising an UV-curing glue and/or a transparent thermo-curing glue.

6. The method according to claim 4, wherein the step (c) employs one of lighting and heating to solidify the binding substance.

7. The method according to claim 4, wherein the metal film is preferably selected from a group of comprising a nickel, a phosphor-nickel and a combination thereof.

8. The method according to claim 4, wherein the depositing layer is made of one of the metal or metal alloys.

9. The method according to claim 4, wherein the depositing layer is formed on the metal film by electroforming method.

10. A method of producing a light guide plate, comprising the steps of:
(a) providing a base board and a dispenser having a cylinder and a nozzle connecting the cylinder, wherein the cylinder is filled with a binding substance;
(b) positioning the nozzle above an area of the base board along a predetermined pattern and unloading a suitable quantity of the binding substance on the area of the base board to form a pattern dot;
(c) solidifying the pattern dot;
(d) repeating steps (b) and (c) appropriately in turn to form a predetermined number of pattern dots on the base board until a first light guide plate is formed;
(e) inspecting an optical performance of the first light guide plate, wherein if the first light guide plate is consistent with a predetermined design of the first light guide plate, entering a subsequent step (f); contrarily, if the first light guide plate is inconsistent with the predetermined design, repeating the steps (a) through (e) appropriately in turn to form the first light guide plate again;
(f) depositing a metal film on a surface having the pattern dots of the first light guide plate;
(g) forming a depositing layer on the metal film by electroforming technology;
(h) stripping off the light guide plate from the metal film to form a core insert for a light guide plate;
(i) providing a mold having a bottom mold part and an upper mold part, and removing the core insert between the bottom mold part and the upper mold part;
(j) manufacturing a second light guide plate by injecting melt resin materials into the mold;
(k) inspecting the optical performance of the second light guide plate, wherein if the second light guide plate is consistent with the predetermined design, mass producing the second light guide plate; contrarily, if the second light guide plate is inconsistent with the predetermined design, repeating the steps (a) through (k) appropriately in turn.

11. The method according to claim 10, wherein the binding substance is selected from a group comprising an UV-curing glue and/or a transparent thermo-curing glue.

12. The method according to claim 10, wherein the step (c) employs one of lighting and heating to solidifying the binding substance to a solid state.

13. The method according to claim 10, wherein the metal film is preferably selected from a group of comprising a nickel, a phosphor-nickel and a combination thereof.

14. The method according to claim 10, wherein the depositing layer is formed on the metal film by electroforming method.

15. The method according to claim 10, wherein the depositing layer is made of one of the metal or metal alloys.

16. The method according to claim 15, wherein the depositing layer may be selected from a group of comprising a nickel and a phosphor-nickel.
